(19) United States
(12) Patent Application Publication
(10) Pub. No.: US 2015/0381077 A1
(43) Pub. Date: Dec. 31, 2015

(54) ENERGY HARVESTING DEVICE

(71) Applicant: LG ELECTRONICS INC., Yeongdeungpo-gu, Seoul (KR)

(72) Inventors: Yonghee PARK, Seoul (KR); Dongil KIM, Seoul (KR); Kwangseok YUN, Seoul (KR); Jinwook KIM, Seoul (KR); Byeonggeun KANG, Seoul (KR)

(73) Assignee: LG ELECTRONICS INC., Yeongdeungpo-gu, Seoul (KR)

(21) Appl. No.: 14/769,315

(22) PCT Filed: Oct. 22, 2013
(86) PCT No.: PCT/KR2013/009435

§ 371 Date: Aug. 20, 2015

(30) Foreign Application Priority Data
Feb. 21, 2013 (KR) 10-2013-0018466
Mar. 7, 2013 (KR) 10-2013-0024281

(51) Int. Cl. H02N 1/00

(52) U.S. Cl. CPC H02N 1/00

(57) ABSTRACT

Disclosed is an energy harvesting device. An energy harvesting device according to the present invention includes a first electrode, a second electrode disposed so as to face the first electrode, a first fluid, a magnetic second fluid, a chamber including a dielectric film arranged between the second electrode and the first fluid, and a magnet arranged outside the chamber for moving the second fluid.

### TECHNICAL FIELD

The present invention relates to an energy harvesting device, and, more particularly, to a fluid-based electrostatic energy harvesting device.

### BACKGROUND ART

Attention has been concentrated on an energy harvesting device which converts waste energy into useful energy.

As widely known methods among energy harvesting methods which produce power from surrounding energy sources and supply the produced power, there are a method for producing power from solar energy using a solar cell, a method for generating power from heat energy using the Seeback effect, and a method for producing power from vibration energy using Faraday's law of electromagnetic induction, the piezoelectric effect, or the magnetostriction effect.

FIG. 1 is a view illustrating the principle of a conventional electrostatic energy harvesting device.

The conventional electrostatic energy harvesting device may cause change of capacitance due to external force, for example, vibration or motion, and thus cause change of electrical charges accumulated in DC bias, thereby generating power through AC current.

In order to increase output power, DC bias, a capacitance varying frequency, and a difference between maximum capacitance and minimum capacitance need to be large. As exemplarily shown in FIG. 1, areas of capacitors and a distance between capacitors which are placed across air are changed. Air serving as a medium has a very small dielectric constant of 1 and is thus difficult to have a large difference between the maximum capacitance and the minimum capacitance, thereby causing a difficulty in outputting high power.

In order to overcome limits of the conventional electrostatic energy harvesting device, U.S. Pat. No. 7,898,096 discloses that an electrically conductive liquid and a dielectric liquid are separated in a plurality of distinct regions and moved by force applied from the outside between channels in which a plurality of electrodes is disposed and, thus, capacitances between the electrodes is greatly changed, thereby generating power at high efficiency and thus producing current.

In the above patent, when the electrically conductive liquid and the dielectric liquid are separated in a plurality of distinct regions while maintaining a designated interval therebewteen and move between the electrodes, high efficiency may be achieved. However, it is difficult to configure the electrically conductive liquid and the dielectric liquid such that the two liquids are separated in a plurality of distinct regions by a designated interval so as to move between the electrodes, it is difficult to manufacture a device in which the electrically conductive liquid and the dielectric liquid are separated by a designated interval so as not to inject air bubbles thereinto by packaging the electrically conductive liquid and the dielectric liquid isolatedly from the outdoor environments, and it is difficult to move the electrically conductive liquid and the dielectric liquid through other methods except for external pressure.

Further, since conductors should contact the entirety of a wall surface and move, they may cause problems, such as a limit of the rate of movement due to friction with the wall surface, generation of wetting with the wall surface during movement, and irreproducibility if the conductors mix with each other.

### DISCLOSURE

### Technical Problem

An object of the present invention is to provide an energy harvesting device which may overcome limits of a conventional electrostatic energy harvesting device and generate high power.

### Technical Solution

In one embodiment of the present invention, an energy harvesting device includes a chamber including a first electrode, a second electrode disposed so as to face the first electrode, a first fluid, a magnetic second fluid, and a second dielectric film disposed between the second electrode and the first fluid, and magnets disposed at the outside of the chamber to cause the second fluid to flow.

The second fluid may be conductive or non-conductive.

The first fluid may be one of air, a conductive fluid and a non-conductive fluid.

The chamber may have one of a channel shape, a cylindrical shape or a polygonal prism shape.

The second dielectric film may include one or two layers and contact the second electrode.

The chamber may further include a first dielectric film disposed between the first electrode and the first fluid.

The first dielectric film may include one or two layers and contact the first electrode.

The magnets may move relative to the first fluid and the second fluid. The magnets may linearly move relative to the first fluid and the second fluid or be rotated relative to the first fluid and the second fluid.

The magnets may be disposed on a first plate, the chamber may be disposed on a second plate, and the first plate and the second plate may linearly move relative to each other or be rotated relative to each other.

The first fluid may be hydrophilic, the second fluid may be hydrophobic, and the chamber may further include a hydrophobic member disposed at a region on the second dielectric film corresponding to the second electrode.

The hydrophobic member may be disposed at a position corresponding to the edge region of the second electrode.

The first fluid may be hydrophilic, the second fluid may be hydrophobic, and the chamber may further include a hydrophobic member disposed on the side walls of the chamber.

The number of the magnets may be at least two and the at least two magnets may be disposed such that poles thereof face opposite directions.

The at least two magnets may be arranged in a linear shape or a circular shape and be disposed such that poles thereof face equal directions, disposed so as to face each other across the chamber, and disposed such that the same poles thereof face each other.

The first electrode and the second electrode may be connected to bias voltage.

### Advantageous Effects

In an energy harvesting device in accordance with one embodiment of the present invention, a magnetic fluid provided in a chamber may flow according to change of an external magnetic field and cause change of capacitance, a pair of electrodes disposed on the chamber may be respectively connected to external DC bias voltage, and current may be generated due to change of capacitance generated in the chamber.

### DESCRIPTION OF DRAWINGS

FIG. 1 is a view illustrating the principle of a conventional electrostatic energy harvesting device.

FIG. 2 is a view illustrating the principle of a fluid-based electrostatic energy harvesting device.

FIGS. 3a and 3b are views illustrating the principle of a magnetic fluid-based electrostatic energy harvesting device.

FIGS. 4a to 4e are views illustrating chambers of a magnetic fluid-based electrostatic energy harvesting device.

FIG. 5 is a view illustrating the principle of generating current in the energy harvesting device.

FIGS. 6a to 6c are views illustrating energy harvesting devices in accordance with embodiments.

FIGS. 7a to 7e are views illustrating energy harvesting devices in accordance with other embodiments.

FIGS. 8a to 8c are views illustrating array configurations of energy harvesting devices in accordance with embodiments.

FIG. 9 is a view illustrating an array configuration of energy harvesting devices in accordance with another embodiment.

FIG. 10 is a perspective view of a manually operated power generation apparatus in accordance with one embodiment of the present invention.

FIG. 11 is an exploded perspective view of the manually operated power generation apparatus in accordance with one embodiment of the present invention.

FIG. 12 is a plan view illustrating a driving unit and a power generation unit of the manually operated power generation apparatus in accordance with one embodiment of the present invention.

FIG. 13 is an exploded perspective view of the manually operated power generation apparatus in accordance with one embodiment of the present invention.

FIG. 14 is a cross-sectional view of the manually operated power generation apparatus in accordance with one embodiment of the present invention. FIG. 15a is a plan view of a stator in accordance with one embodiment of the present invention.

FIG. 15b is a plan view of a stator in accordance with another embodiment of the present invention.

FIGS. 16a and 16b are plan views illustrating movement of a one-way bearing in accordance with the present invention.

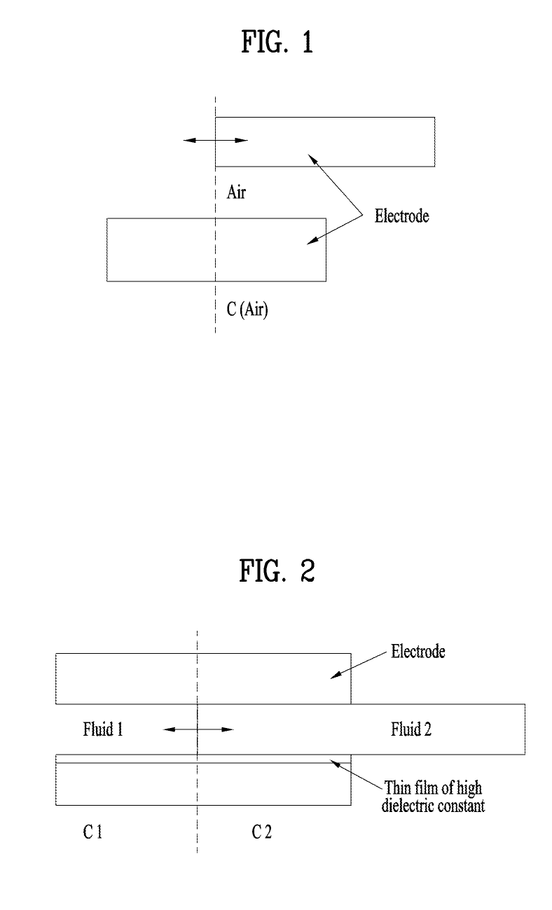

### BEST MODE

Reference will now be made in detail to the preferred embodiments of the present invention, examples of which are illustrated in the accompanying drawings.

In the following description of the embodiments, it will be understood that, when each element is referred to as being formed “on” or “under” another element, it can be directly “on” or “under” another element or be indirectly formed with one or more intervening elements therebetween. In addition, it will also be understood that “on” or “under” the element may mean an upward direction and a downward direction of the element.

FIG. 2 is a view illustrating the principle of a fluid-based electrostatic energy harvesting device.

The energy harvesting device in accordance with this embodiment may change capacitance using external force and cause change in charges accumulated in DC bias, thus generating power through AC current. Fluid movement may be used to change capacitance and a conductive fluid may be used to change capacitance based on fluid movement.

In order to change capacitance using movement of a conductive fluid, a conductive fluid and a non-conductive fluid may be provided so that, when the conductive fluid and the non-conductive fluid move, capacitance is changed mainly by movement of the conductive fluid. For fluid movement, at least one of the conductive fluid and the non- conductive fluid may be a magnetic fluid and the fluids may be moved by changing surrounding magnetic force.

As exemplarily shown in FIG. 2, when a fluid 1 and a fluid 2 move, capacitances C1 and C2 in two regions may be changed and current may applied to electrodes around the fluid 1 and the fluid 2. Here, one of the fluid 1 and the fluid 2 may be a conductive fluid and the other may be a dielectric fluid. Further, a dielectric may be disposed between at least one electrode and the fluids 1 and 2 so as to prevent short circuit and a thin film of a high dielectric constant may be used as the dielectric. As described above, as a magnet moves or disposition of the magnet is changed, a magnetic field may be changed and, thereby, the fluid 1 and the fluid 2, at least one of which is magnetic, may flow.

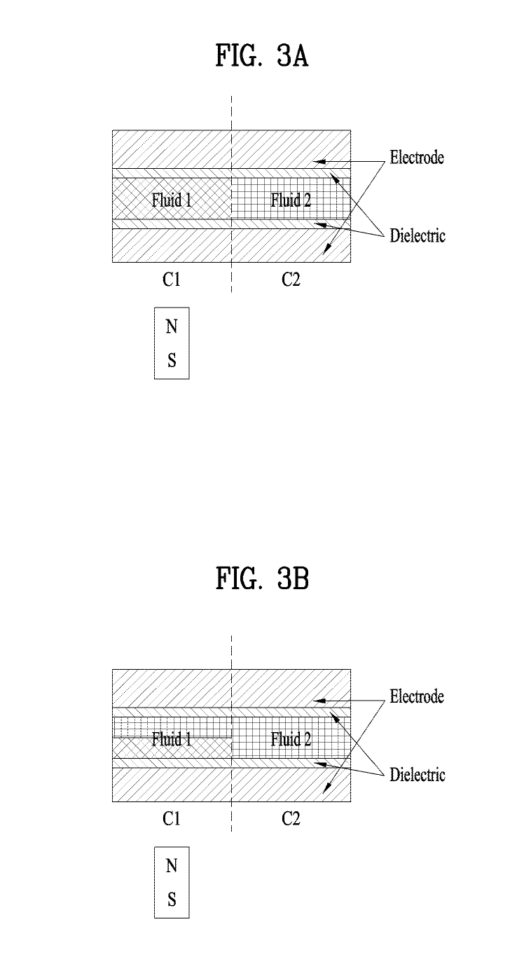

FIGS. 3a and 3b are views illustrating the principle of a magnetic fluid-based electrostatic energy harvesting device.

In order to change capacitance through movement of a conductive fluid, both a conductive fluid and a non-conductive fluid are provided. When the conductive fluid and the non-conductive fluid move, capacitance may be changed mainly by movement of the conductive fluid. In order to move the fluids, at least one of the conductive fluid and the non-conductive fluid may be a magnetic fluid and the fluids may be moved by changing surrounding magnetic force.

As exemplarily shown in FIG. 3a, when a fluid 1 and a fluid 2 move, capacitances C1 and C2 in two regions may be changed and current may applied to electrodes around the fluid 1 and the fluid 2. Here, one of the fluid 1 and the fluid 2 may be a conductive fluid and the other may be a dielectric fluid.

Further, a dielectric may be disposed between at least one electrode and the fluids 1 and 2 so as to prevent short circuit and a thin film of a high dielectric constant may be used as the dielectric. As described above, as a magnet moves or disposition of the magnet is changed, a magnetic field may be changed and, thereby, the fluid 1 and the fluid 2, at least one of which is magnetic, may flow.

In FIG. 3a, the fluid 1 may be a magnetic fluid and the fluid 2 may be a non-magnetic fluid. Here, the capacitance C1 may be the minimum and the capacitance C2 may be the maximum.

In FIG. 3a, since the fluid 1 and the fluid 2 fully fill a channel, it is difficult to move the fluid 1 and the fluid 2. Therefore, as exemplarily shown in FIG. 3b, an embodiment in which a fluid 1 fills only a part of a channel may be considered. In FIG. 3b, the fluid 1 may be a magnetic fluid, the fluid 2 may be a non-magnetic fluid, the capacitance C1 may be the minimum, and the capacitance C2 may be the maximum.

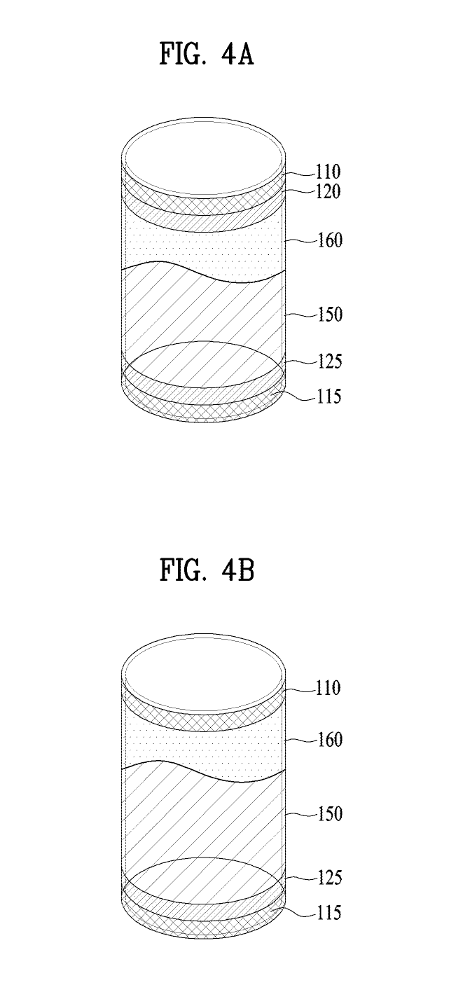

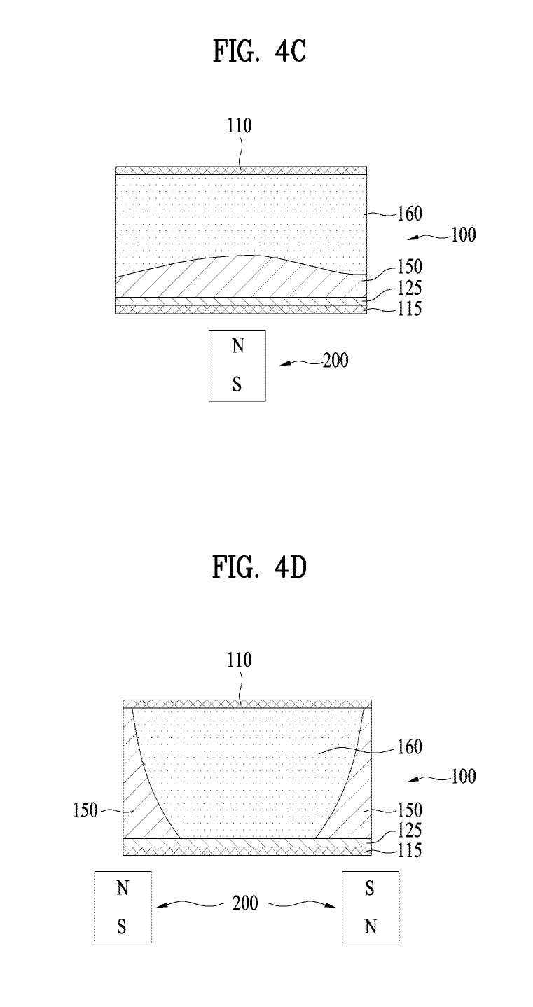

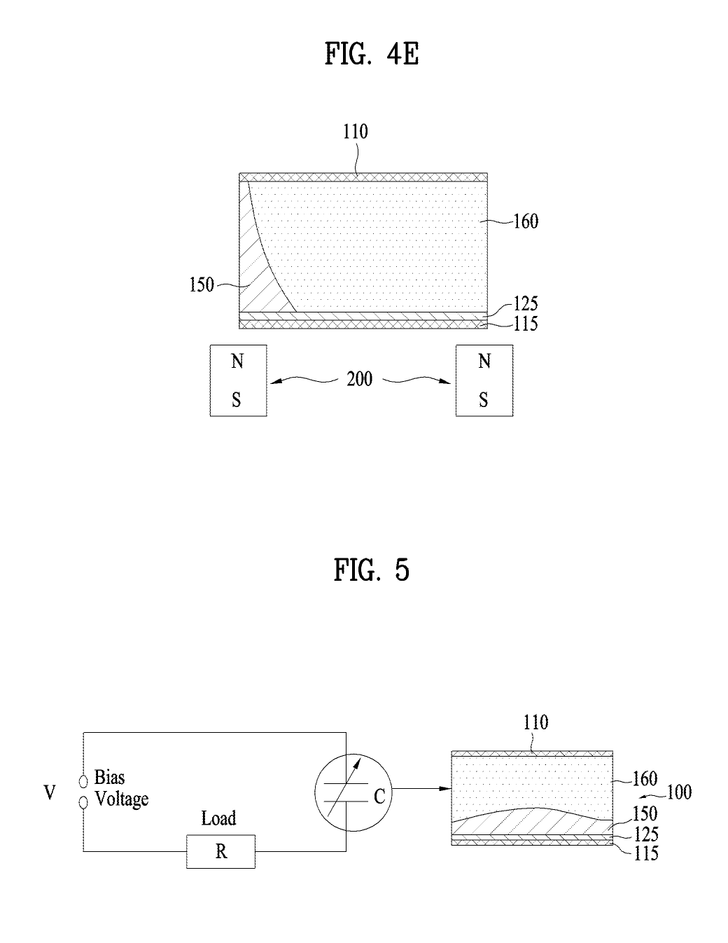

FIGS. 4a to 4e are views illustrating chambers of a magnetic fluid-based electrostatic energy harvesting device.

Within a chamber 100 in accordance with one embodiment, at least two fluids having different physical properties, which do not mix with each other, may be present. The chamber 100 may have a cylindrical shape or a polygonal prism shape but is not limited thereto. The chamber 100 may have a sealed space therein so as to store a first fluid 160 and a second fluid 150 and have two flat surfaces facing each other such that a first electrode 110 and a second electrode 115 are disposed thereon. The first fluid 160 and the second fluid 150 provided within the chamber 100 do not react and not mix with each other and at least one fluid is magnetic such that the fluids within the chamber may flow based on change of magnetic force. In this embodiment, the second fluid 150 may be magnetic.

The space within the chamber 100 to receive the first fluid 160 and the second fluid 150 is defined as a housing 170. The housing 170 may be formed of a non-conductive material and prevent short circuit with a conductive material. The first electrode 110 and the second electrode 115 may be formed of a conductive material, for example, a metal, such as aluminum (Ag) or silver (Ag). In the embodiment shown in FIG. 3a, a first dielectric film 120 is disposed between the first fluid 160 and the first electrode 110, a second dielectric film 125 is disposed between the second fluid 150 and the second electrode 115 and, in the embodiment shown in FIG. 4b, only a first dielectric film 120 is disposed. The first dielectric film 120 and the second dielectric film 125 may be formed in a single layer or two layers.

A boundary between the first fluid 160 and the second fluid 150 is shown by a curved line but may have other shapes. Further, the volumes or weights of the first fluid 160 and the second fluid 150 may not be the same and, in order to cause change in capacitance, the volume or weight of a magnetic fluid should not be excessively small.

In this embodiment, at least one of the first fluid 160 and the second fluid 150 may be magnetic such that the first fluid 160 and/or the second fluid 150 may move according to change of a magnetic field formed in the chamber 100. The first fluid 160 and the second fluid 150 may be gas in addition to liquid.

For example, the first fluid 160 may be air and the second fluid 150 may be a magnetic fluid and, in this case, the second fluid 150 may be conductive. Otherwise, the first fluid 160 may be a conductive fluid and the second fluid 150 may be a magnetic fluid and, in this case, the second fluid 150 may be non-conductive. Further, the first fluid 160 may be a dielectric fluid and the second fluid 150 may be a magnetic fluid and, in this case, the second fluid 150 may be conductive.

That is, the first fluid 160 and the second fluid 150 may not mix with each other and not react with each other. One of the two fluids may be magnetic and thus change capacitance in the chamber 100 according to change of a magnetic field. Even if both the first fluid 160 and the second fluid 150 are magnetic, the first fluid 160 and the second fluid 150 may flow according to change of a magnetic field but, in this case, due to magnetic force between the first fluid 160 and the second fluid 150, the flow of the first fluid 160 and the second fluid 150 may be lower than the flow in the above-described case.

Further, in order to change capacitance in the chamber 100, one of the first fluid 160 and the second fluid 150 may be conductive and the other may be non-conductive. If both the first fluid 160 and the second fluid 150 are conductive, the fluids move due to magnetic force between the first fluid 160 and the second fluid 150 within the chamber 100 but do not cause change in capacitance.

In embodiments shown in FIGS. 4c to 4e, the structure of the chamber 100 shown in FIG. 4b is schematically illustrated and the chamber 100 includes a first fluid 160, a second fluid 129, a first electrode 110, a second electrode 115, and a second dielectric film 125. The chamber 100 of the energy harvesting device may include the structures of the above-described embodiments in addition to the illustrated structure.

A magnet(s) 200 to change a magnetic field in the chamber 100 is/are disposed at the outside of the chamber 100 and, in addition to a conventional magnet having the N and P poles, other devices which may change a magnetic field may be used as the magnet(s) 200. For example, a permanent magnet or an electromagnet may be used.

In the embodiment shown in FIG. 4c, the magnet 200 is disposed corresponding to the central region of the second fluid 150 and a region of the boundary between the first fluid 160 and the second fluid 150 corresponding to the magnet 200 is changed. The position of the magnet 200 may differ from the illustrated position and, in this case, the boundary between the first fluid 160 and the second fluid 150 may be changed.

In the embodiment shown in FIG. 4d, two magnets 200 are disposed such that the poles of the magnets 200 facing the chamber 100 are different. The embodiment shown in FIG. 4e is similar to the embodiment shown in FIG. 4d but, in the embodiment shown in FIG. 4e, two magnets 200 are disposed such that the poles of the magnets 200 facing the chamber 100 are equal.

Since the distance between the first electrode 110 and the second electrode 115 and the cross-sectional areas of the first electrode 110 and the second electrode 115 are fixed, capacitance generated from the respective devices shown in FIGS. 4c to 4e is proportional to the dielectric constant of a material disposed between the first electrode 120 and the second electrode 115 and, capacitance may increase as change of the dielectric constant of the material increases, i.e., as the first fluid 160 and the second fluid 150 flow greatly.

Therefore, capacitances of the chambers having the structures shown in FIGS. 4d and 4e may be greater than capacitance of the chamber having the structure shown in FIG. 4c.

FIG. 5 is a view illustrating the principle of generating current in the energy harvesting device.

The first fluid 160 and the second fluid 150 may be provided within the chamber 100, the first fluid 160 and the second fluid 150 may move within the chamber 100 due to change of a magnetic field by relative motion of a magnet (not shown), and change of capacitance between the first electrode 120 and the second electrode 115 may be generated.

In FIG. 5, if the first fluid 160 is a dielectric fluid and the second fluid 150 is a magnetic conductive fluid, the second fluid 150 may flow by magnetic force in the direction of the magnetic field formed by the magnet (not shown) and the first fluid 160 may also flow. If the first fluid 160 which is dielectric consists of electrically polar molecules, the polar molecules may be arranged in the direction of the magnetic field and thus generate dielectric polarization.

The first electrode 120 and the electrode 115 may be connected to external DC bias voltage and current may be generated due to change of capacitance generated between the first electrode 120 and the second electrode 115 by flow of the second fluid 150 and dielectric polarization of the first fluid 160.

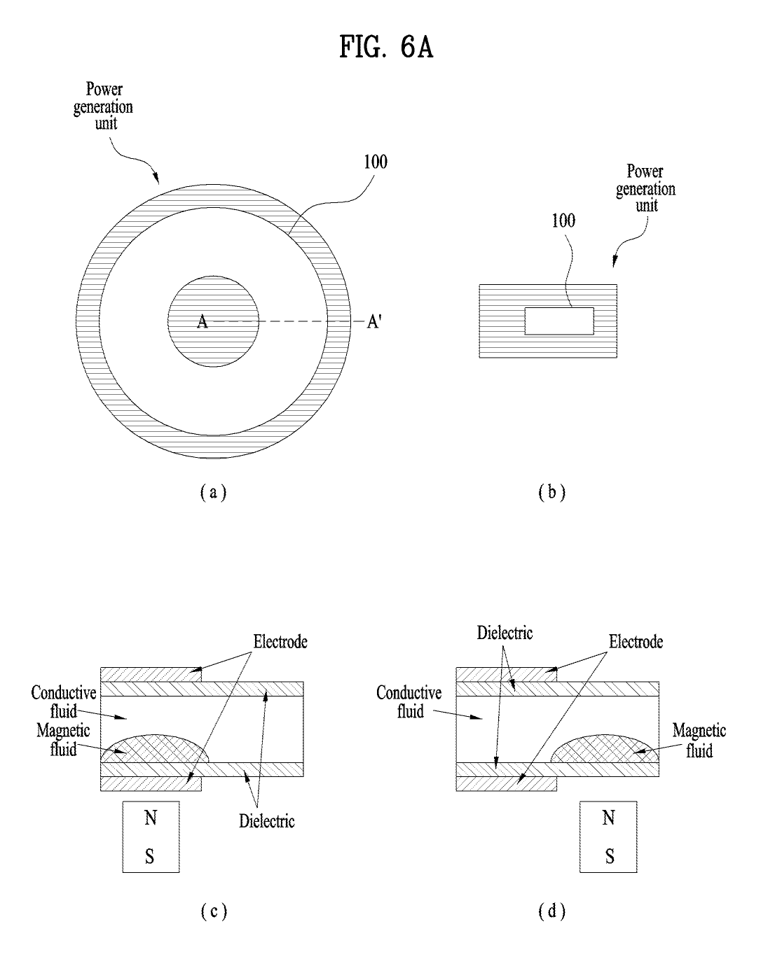

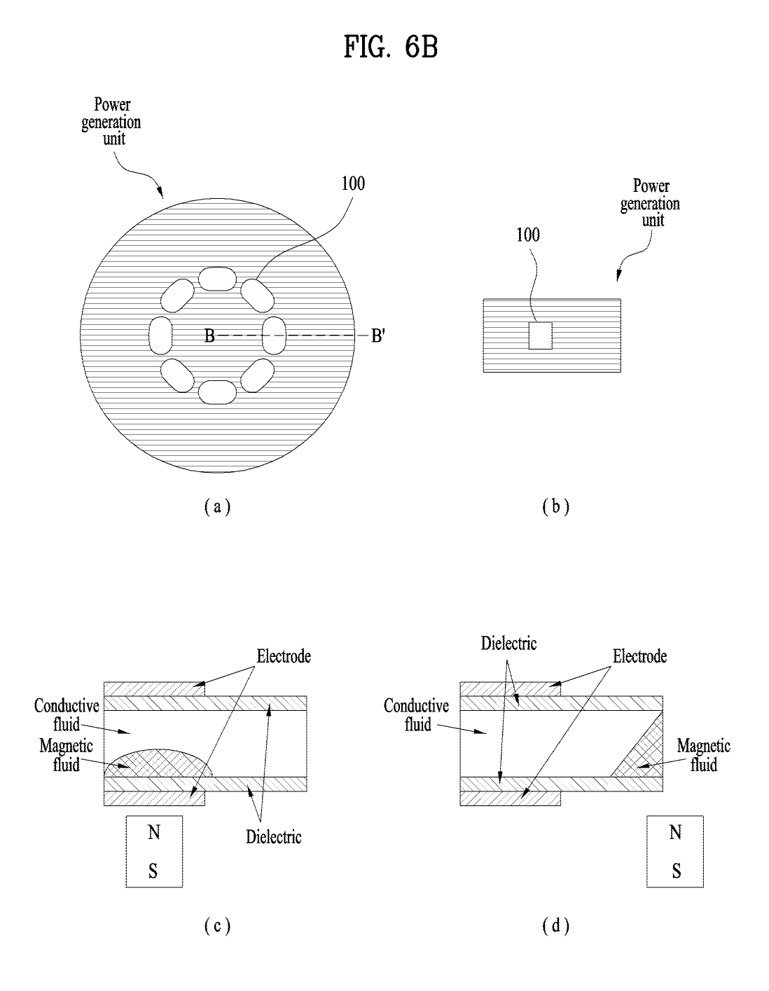

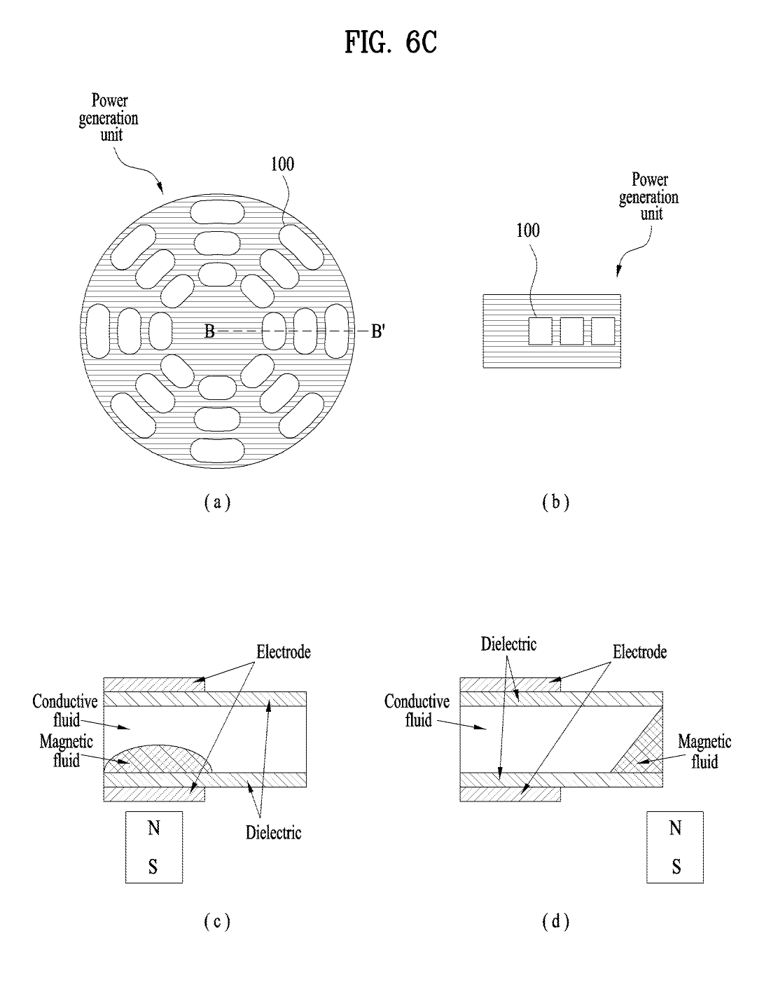

FIGS. 6a to 6c are views illustrating energy harvesting devices in accordance with embodiments. Hereinafter, a part including chambers 100 may be referred to as a power generation unit and a part including magnets may be referred to as a driving unit.

FIG. 6a illustrates the power generation unit and the driving unit of the energy harvesting device and (b) is a cross-sectional view of (a) taken along line A-A′. That is, the chamber 100 included in the power generation unit of FIG. 6a differs from the chamber 100 having a cylindrical shape shown in FIG. 4a in that the chamber 100 included in the power generation unit of FIG. 6a has a channel shape, such as a donut. (c) and (d) illustrate exemplary energy harvesting devices.

When the chamber 100 executes circular motion or the magnet executes circular motion, when a conductive fluid and a magnetic fluid (non-conductive fluid) move, capacitance may be changed mainly by movement of the conductive fluid.

In FIG. 6a, while the magnet or the chamber 100 is rotated, capacitance may become the minimum when the electrodes are disposed between the magnet and the magnetic fluid, as exemplarily shown in (c), and capacitance may become the maximum when the magnetic fluid does not correspond to the electrodes, as exemplarily shown in fig. (d).

Chambers 100 included in a power generation unit of FIG. 6b do not have a channel shape but are disposed in a cell shape. In FIG. 6b, while the magnet or the chambers 100 are rotated, capacitance may become the minimum when electrodes are disposed between the magnet and the magnetic fluid, as exemplarily shown in (c), and capacitance may become the maximum when the magnetic fluid does not correspond to the electrodes, as exemplarily shown in fig. (d).

In the embodiment shown in FIG. 6c, chambers 100 are provided within a power generation unit in a similar manner to the embodiment shown in FIG. 6b. However, the embodiment shown in FIG. 6c differs from the embodiment shown in FIG. 6b in that the chambers 100 disposed in the cell shape form a plurality of layers. As circumstances require, the sizes of the cell-shape chambers 100 may not be regular and the size of the energy harvesting device may increase in a direction from the central region to the edge region of the power generation unit, but the disclosure of the present invention is not limited thereto.

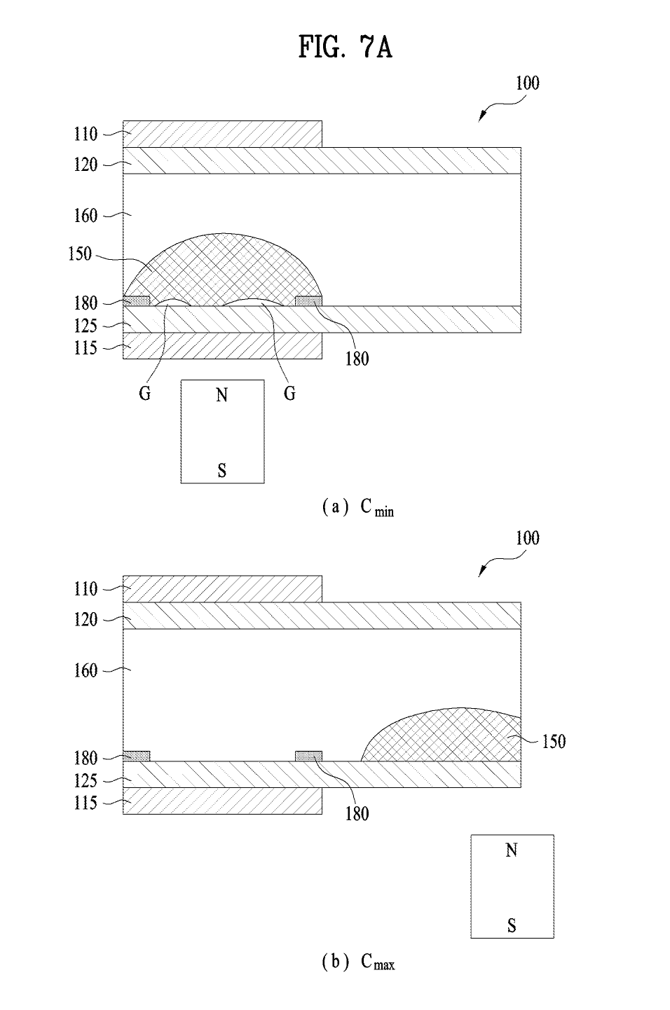

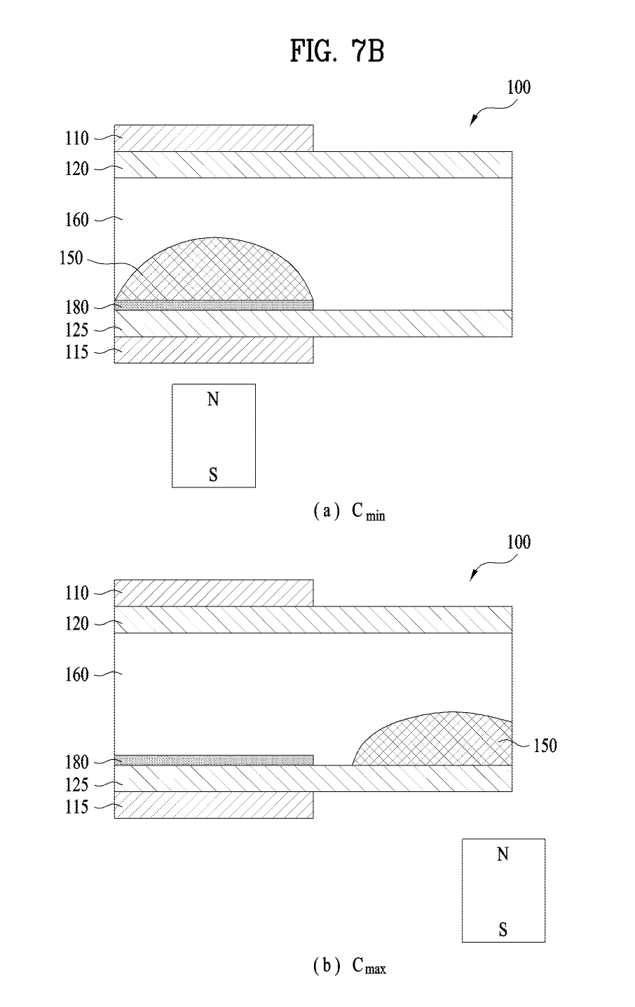

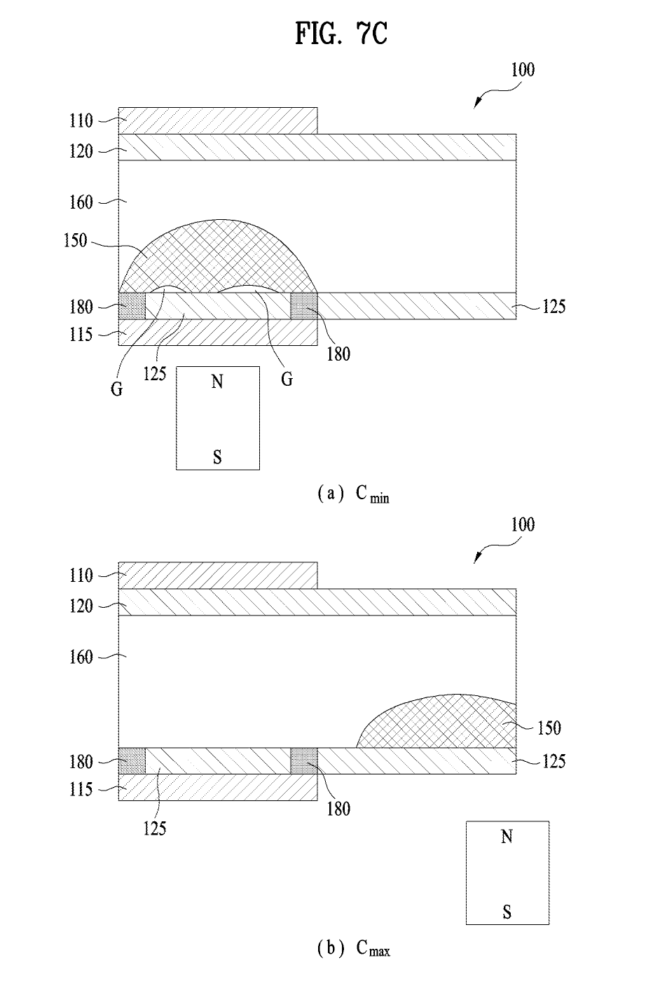

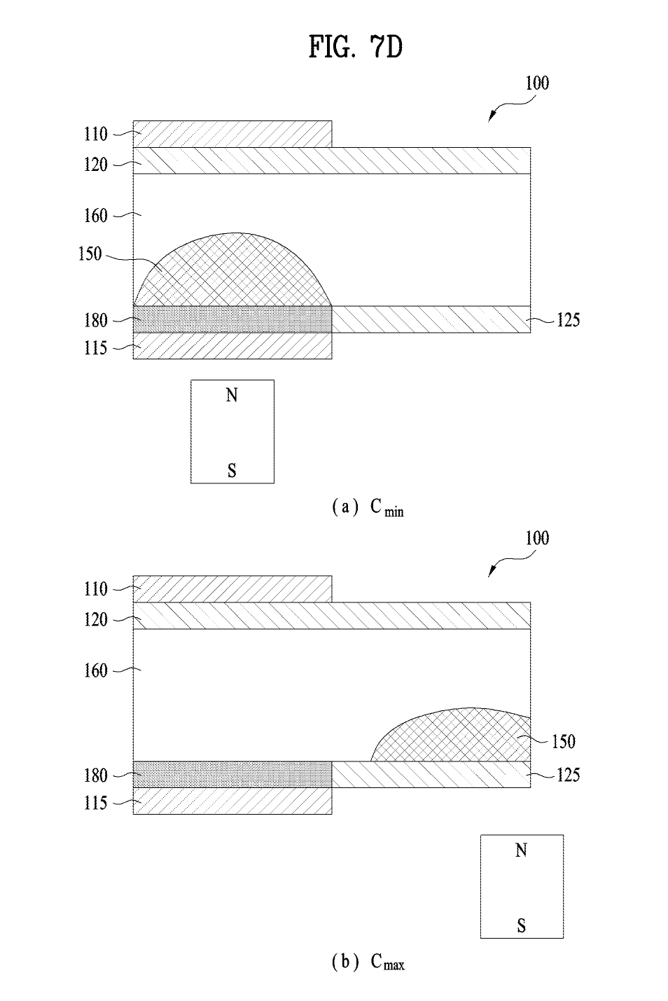

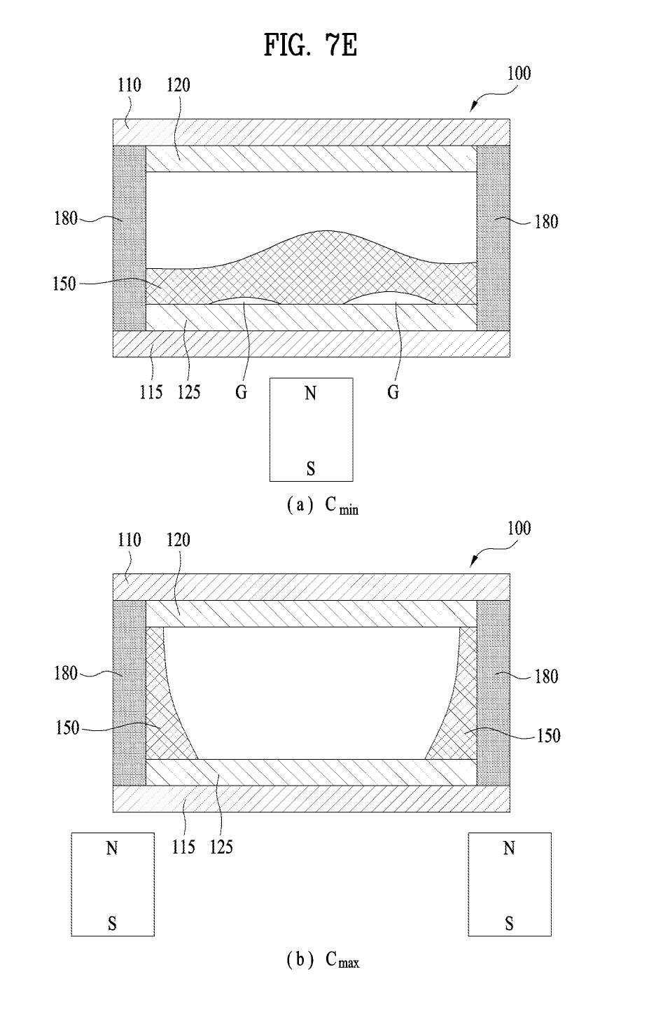

FIGS. 7a to 7e are views illustrating energy harvesting devices in accordance with other embodiments.

With reference to FIG. 7a, an energy harvesting device includes a first electrode 110, a second electrode 115, a first fluid 160 and a second fluid 150. The first electrode 110 and the second electrode 115 are disposed so as to face each other. It is assumed that the first fluid 160 is a conductive fluid and the second fluid 150 is a magnetic fluid. In order to prevent short circuit between the first fluid 160, i.e., the conductive fluid, and the electrodes 110 and 115, a first dielectric 120 may be disposed between the first fluid 160 and the first electrode 110 and a second dielectric 125 may be disposed between the first fluid 160 and the second electrode 115.

A hydrophobic member 180 corresponding to the electrode 115 may be disposed on the second dielectric 125. In this case, it is assumed that the second dielectric 125 is hydrophilic.

The hydrophobic member 180 may be disposed on one surface of the second dielectric 125 contacting the first fluid 160 and/or the second fluid 150 not one surface of the second dielectric 125 contacting the second electrode 115. The hydrophobic member 180 may be disposed corresponding to the edge region of the second electrode 115.

Since the second fluid 150, i.e., the magnetic fluid, is generally hydrophobic, if the second dielectric 125 is hydrophilic, the second fluid 150 and the second dielectric 125 are not close to each other. Therefore, it is difficult to dispose the second fluid 150 so as to cover the entirety of a part of the second dielectric 125 corresponding to the second electrode 115 and, thus, implementation of effective Cmin is difficult.

In accordance with this embodiment, the second fluid 150 may be stably disposed at a part of the second dielectric 125 corresponding to the second electrode 115 by the hydrophobic member 180 disposed on the second dielectric 125 corresponding to the edge region of the second electrode 115. Therefore, as exemplarily shown in (a), the second fluid 150 may isolate the first electrode 110 and the second electrode 115 from each other and thus effectively implement Cmin. Spaces G in which no second fluid 150 is present may be present at parts of the second dielectric 125 corresponding to the second electrode 115 in which no hydrophobic member 180 is disposed. The first fluid 160 which is hydrophilic may be present in the spaces G.

With reference to FIG. 7b, a hydrophobic member 180 may be disposed on the second dielectric 125 corresponding to the center region of the second electrode 115 in addition to the edge region of the second electrode 115. FIG. 7b illustrates the hydrophobic member 180 as being continuously disposed from a part corresponding to the edge region to a part corresponding to the central region of the second electrode 115 but the disclosure is not limited thereto. Differently from FIG. 7a, in FIG. 7b, a space G in which no hydrophobic member 180 is disposed may not be present on a part of the second dielectric 125 corresponding to the second electrode 115. However, when the area of the hydrophobic member 180 is excessively large, in the case of implementation of Cmax, as exemplarily shown in (b), tailing in which the second fluid 150 does not completely deviate from the region of the hydrophobic member 180 corresponding to the second electrode 115 may occur when the second fluid 150 flows along a magnet.

With reference to FIG. 7c, a part of the second dielectric 125 corresponding to the edge region of the second electrode 115 may consist of a hydrophobic member 180. That is, the hydrophobic member 180 is not separately disposed on one surface of the second dielectric 125 but the hydrophobic member 180 may form a part of the second dielectric 125. For example, the hydrophobic member 180 included in the second dielectric 125 may be formed by doping the second dielectric 125 with a hydrophobic material when the second dielectric 125 is formed. Other parts are similar to those of the embodiment shown in FIG. 7a and a detailed description thereof will thus be omitted.

With reference to FIG. 7d, a part of the second dielectric 125 corresponding to the central region of the second electrode 115 as well as the edge region of the second electrode 115 may consist of a hydrophobic member 180. Other parts are similar to those of the embodiments shown in FIGS. 7b and 7c and a detailed description thereof will thus be omitted.

The chambers 100 of the above-described energy harvesting devices shown in FIGS. 7a to 7d may have a donut shape or a cell shape. However, it is assumed that the chamber 100 of the energy harvesting device shown in FIG. 7e, which will be described below, has a cell shape.

With reference to FIG. 7e, the chamber 100 has a cell shape and thus has side walls. In the embodiment shown in FIG. 7e, the side walls of the chamber 100 include hydrophobic members 180. The hydrophobic members 180 are disposed along the side walls of the chamber 100. As circumstances require, the hydrophobic members 180 themselves may be the side walls of the chamber 100 or the hydrophobic members 180 may be separately provided inside the side walls of the chamber 100.

The first electrode 110 and the second electrode 115 may have a width corresponding to the width of the energy harvesting device.

With reference to (a) in which Cmin is implemented, it may be confirmed that the second fluid 150 having hydrophobicity is stably supported by the hydrophobic members 180 present on the side walls of the energy harvesting device and effectively isolates the first electrode 110 and the second electrode 115 from each other. In (a), spaces G in which the second fluid 150 is not present may be present between the second dielectric 125 having hydrophilicity and the second fluid 150 having hydrophobicity. In the spaces G, the first fluid 160 having hydrophilicity may be present.

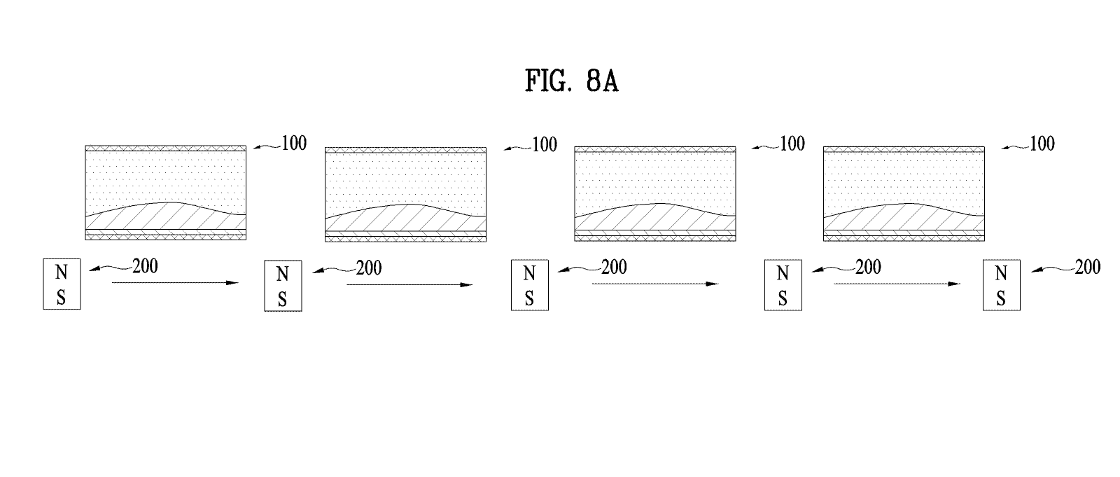

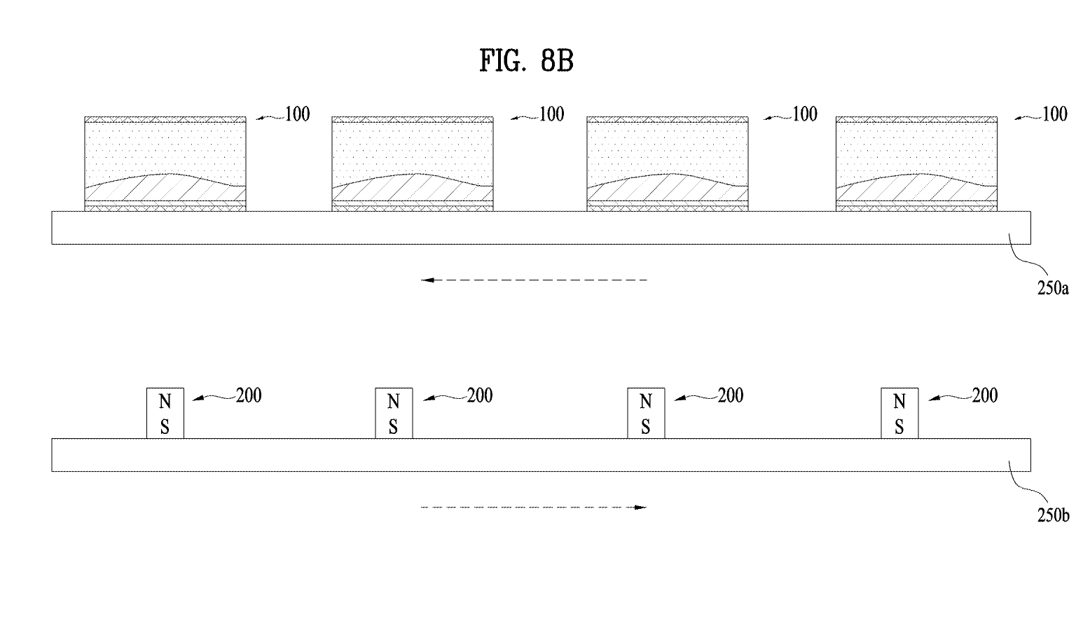

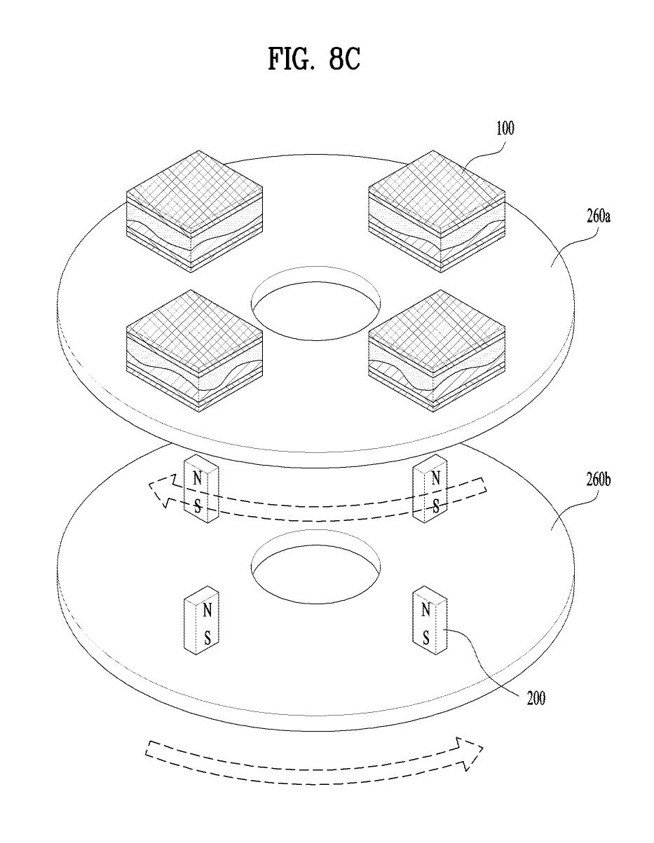

FIGS. 8a to 8c are views illustrating array configurations of energy harvesting devices in accordance with embodiments.

In the embodiment shown in FIG. 8a, a plurality of chambers 100 may be disposed, a first fluid and a second fluid may be provided within the each chamber 100, as exemplarily shown in FIGS. 4a to 4d, and a magnet 200 may linearly move relative to each chamber 100. A part including the chambers 100 may be referred to as a power generation unit and a part including the magnets 200 may be referred to as a driving unit.

In the embodiment shown in FIG. 8b, respective chambers 100 are disposed on a first plate 250a and magnets 200 are disposed on a second plate 250b. Here, it is illustrated that the first plate 250a and the second plate 250b move in opposite directions but, although only one of the two plates moves, when the first plate 250a and the second plate 250b move relative to each other, capacitance within the chambers 100 may be changed by the flow of the fluids within the chambers 100.

In the embodiment shown in FIG. 8c, a first circular plate 260a and a second circular plate 260b are provided and chambers 100 and magnets 200 are disposed on the first plate 260a and the second plate 260b. Here, if the first plate 260a is fixed and the second plate 260b is rotated, as exemplarily shown in FIG. 8c, or if the first plate 260a is rotated and the second plate 260b is fixed, fluids within the chambers 100 and the magnets 200 circularly move relative to each other and, thus, capacitance within the chambers 100 may be changed by the flow of the fluids within the chambers 100.

In the embodiments shown in FIGS. 8a to 8c, when a material having high permeability is disposed between the respective chambers 100, the intensity of magnetic force may be increased, the flow of the magnetic fluid within the chambers 100 may become fast, and the rate of change of capacitance may be increased. That is, when a material having high permeability, for example, a ferromagnetic substance, such as iron, or a ferrimagnetic substance, is disposed between the chambers 100, the intensity of a magnetic field applied to the magnetic fluid or the intensity of change of the magnetic field may be increased and thus accelerate the flow of the magnetic fluid.

Further, when the magnets 200 approach the chambers 100 or retreat at a regular speed or when the magnets 200 disposed so as to have poles of different directions periodically approaches the chambers 100, the flow of the fluid within the chambers 100 may be repeated in a regular period, change of capacitance may have a constant frequency and high efficiency energy harvesting may be carried out.

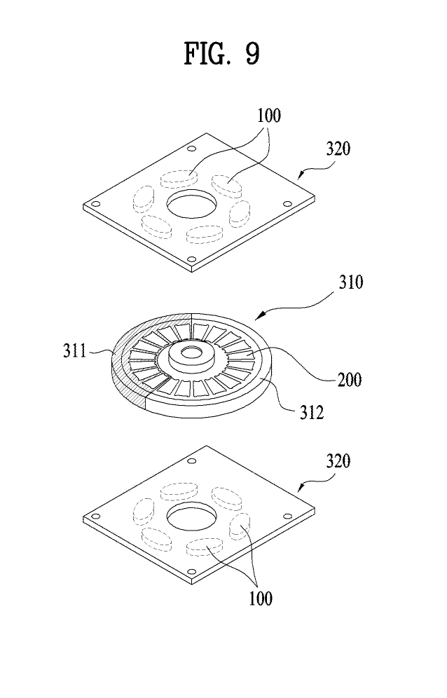

FIG. 9 is a view illustrating an array configuration of energy harvesting devices in accordance with another embodiment.

The array configuration of FIG. 9 includes power generation units 320 including chambers 100 of the above-described energy harvesting device and a driving unit 310 including magnets 200 of the above-described energy harvesting device. Although FIG. 9 illustrates the power generation units 320 as being disposed above and below the driving unit 310, the power generation unit 320 may be disposed only above or below the driving unit 310.

The driving unit 310 includes a plurality of magnets 200. The magnet 200 is the same as the above-described magnets 200 shown in FIGS. 3a to 7e and a detailed description thereof will thus be omitted.

The power generation unit 320 includes the chambers 100. The chamber 322 may be formed in a channel type or a cell type. The chambers 100 are the same as the above-described chambers shown in FIGS. 3a to 7e and a detailed description thereof will thus be omitted. FIG. 9 exemplarily illustrates cell-type chambers 100.

The driving unit 310 may include a first part 311 having a relatively large weight and a second part 312 having a relatively small weight. Since the center of gravity of the driving unit 310 is not located at the center of the driving unit 310 but is biased to the first part 311, the driving unit 310 is eccentrically rotated. For example, if the energy harvesting device in accordance with the present invention is used in a watch or other portable apparatuses, when a user only carries the watch or other portable apparatuses, energy may be generated due to eccentric rotation of the driving unit 310 without a separate power apparatus. The thicknesses of the first part 311 and the second part 312 may be the same or the thickness of the first part 311 may be greater than the thickness of the second part 312, and the disclosure is not limited thereto. If the thicknesses of the first part 311 and the second part 312 are the same, arrangement of the driving unit 310 and the power generation unit 320 is advantageous.

Although FIGS. 8 and 9 exemplarily illustrate the driving unit as being formed in a rotation type, as circumstances require, the driving unit may be formed in non-rotation type. The non-rotation type driving unit may mean that the rotation or movement of the driving unit is linear.

In the energy harvesting device in accordance with the above-described embodiment, since the magnetic fluid flows according to movement of the magnet and thus the conductive fluid flows, electrostatic energy may be generated. Further, a capacitance difference value increases due to the fluids used as media and thus high efficiency may be acquired, the dielectric is used between the electrode and the magnetic fluid and thus high efficiency may be expected due to improvement in dielectric constant, and arrangement of the magnets and the electrodes is adjusted and thus operating frequency may be raised.

Electrostatic energy generation has been described above and, hereinafter, electromagnetic energy generation will be described.

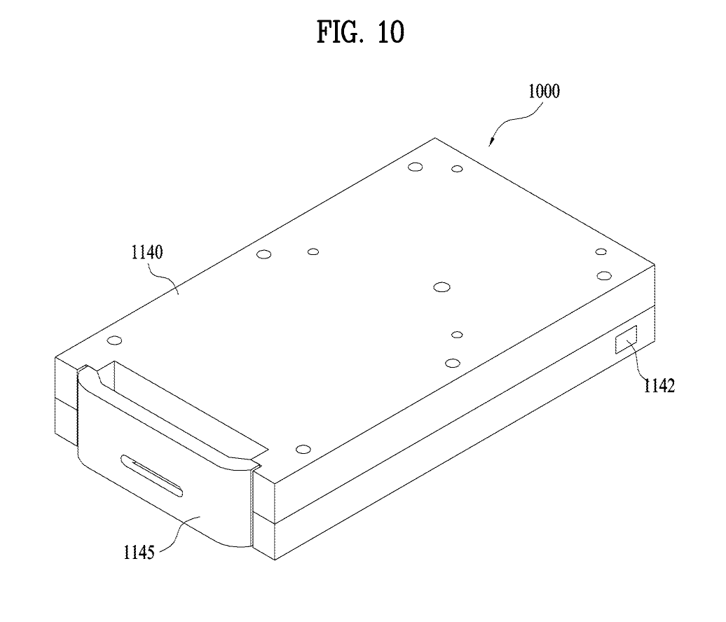

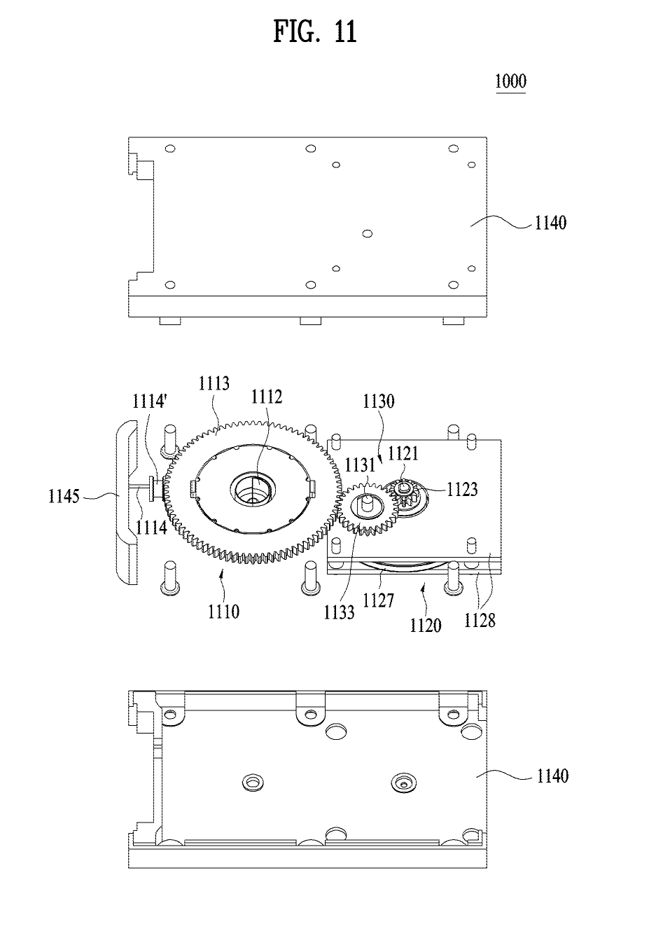

FIG. 10 is a perspective view of a manually operated power generation apparatus in accordance with one embodiment of the present invention and FIG. 11 is an exploded perspective view of the manually operated power generation apparatus in accordance with one embodiment of the present invention.

A manually operated power generation apparatus 1000 in accordance with the present invention includes a housing 1140 to receive a driving unit 1110 and a power generation unit 1120 therein, and a string handle 1145 located at one end of the housing 1140 and connected to a string 1114 to apply force of rotating the driving unit 1110.

When a user grips the housing 1140 and pulls the string handle 1145, power generation is carried out and, when the user releases the string handle 1145, the string 1145 is rewound and the string handle 115 returns to its original position.

With reference to FIG. 11, the manually operated power generation apparatus 1000 includes the driving unit 1110 connected to the string handle 1145 by the string 1114, rotated in a first direction when the string 1114 is pulled, and rotated in a second direction when the string 1114 is released, and the power generation unit 1120 rotated in a third direction by force transmitted from a driving gear 1113 and thus producing power when the driving unit 1110 is rotated.

The manually operated power generation apparatus 1000 may further include a connection unit 1130 interposed between the driving unit 1110 and the power generation unit 1120 and transmitting power. Although the driving unit 1110 and the power generation unit 1120 may be directly connected without the connection unit 1130, a power generation gear 1123 of the power generation unit 1120 is small and, thus, the connection unit 1130 interposed between the driving gear 1113 and the power generation gear 1123 may form a proper separation distance between the driving unit 1110 and the power generation unit 1120.

Since the size of the driving gear 1113 is greater than the size of the power generation gear 1123, when the driving gear 1113 is rotated one time, the power generation gear 1123 is rotated several tens of times to generate power.

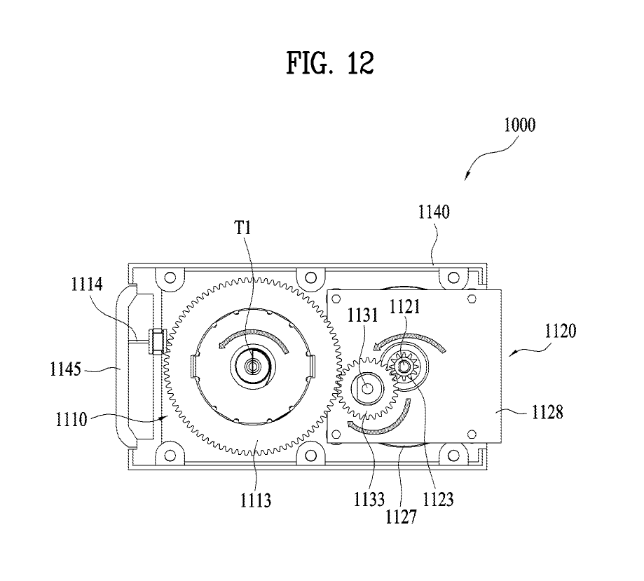

FIG. 12 is a plan view illustrating the driving unit and the power generation unit of the manually operated power generation apparatus in accordance with one embodiment of the present invention.

With reference to FIG. 12, when the string 1114 is pulled, the driving gear 1113 is rotated in the counterclockwise direction, a connection gear 1133 engaged with the driving gear 1113 is rotated in the clockwise direction, and the power generation gear 1123 is rotated in the counterclockwise direction.

Therefore, in accordance with the embodiment shown in FIG. 12, the first direction of the driving gear 1113 is the counterclockwise direction, the second direction of the connection gear 1133 is the clockwise direction, and the third direction of the power generation gear 1123 to generate power is the counterclockwise direction.

Differently, if the driving gear 1113 and the power generation gear 1123 are disposed so as to be directly engaged with each other, when the driving gear 1113 is rotated in the first direction, the power generation gear 1123 is rotated in the opposite direction, i.e., the second direction. Therefore, the third direction of the power generation gear 1123 to generate power is the same as the second direction.

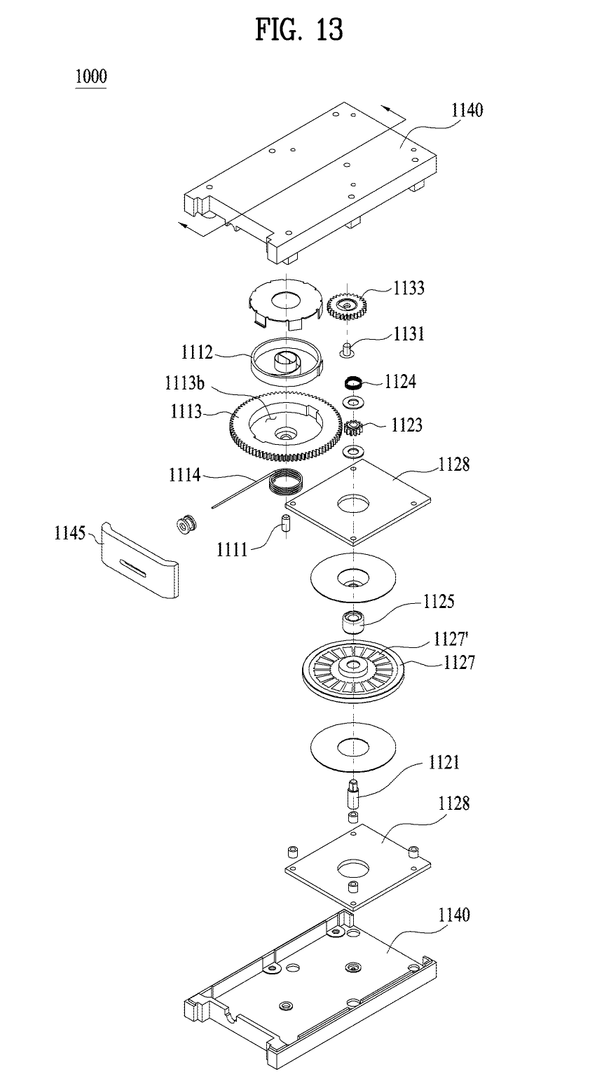

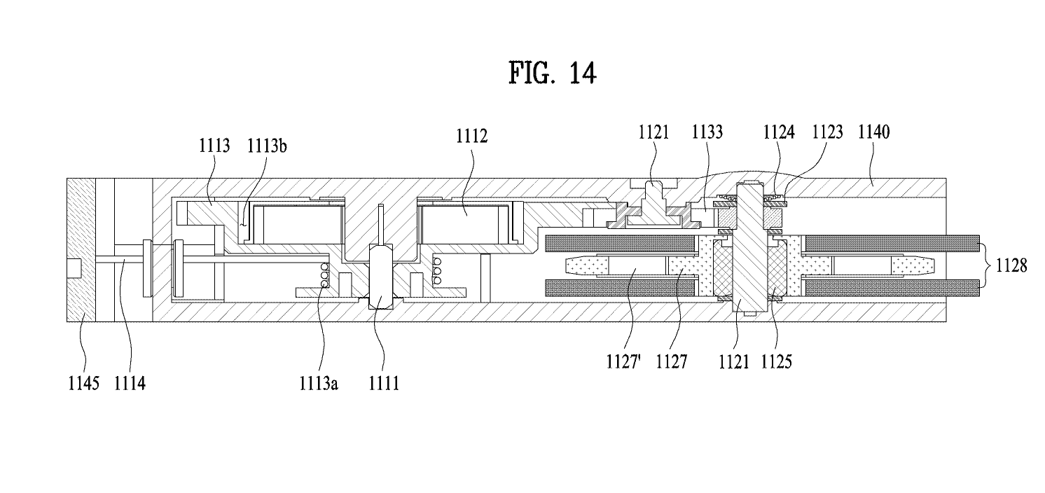

FIG. 13 is an exploded perspective view of the manually operated power generation apparatus in accordance with one embodiment of the present invention and FIG. 14 is a cross-sectional view of the manually operated power generation apparatus in accordance with one embodiment of the present invention. Hereinafter, with reference to FIGS. 13 and 14, the detailed configuration of the manually operated power generation apparatus in accordance with one embodiment of the present invention will be described.

With reference to FIGS. 13 and 14, the driving unit 1113 includes the driving gear 1113, a spiral spring 1112, a driving shaft 1111, and the string 1114. The driving shaft 1111 serves as a rotary shaft of the driving unit 1110 so that the driving gear 1113 is rotated about the driving shaft 1111.

The string 1114 is a linear member wound on the driving gear 1113, and the string 1114 is unwound and the driving gear 1113 is rotated in the first direction when a terminal of the string 1114 is pulled. Here, the driving shaft 1111 is fixed to the housing 1140 so as not to be rotated.

The terminal of the string 1114 is connected to the string handle 1145 so as to be easily pulled and, in the wound state of the string 1114, the string handle 1145 is caught by the housing 1140. Therefore, the string handle 1145 serves to limit the range of winding the string 1114 so that the string 1114 is not completely wound on the driving gear 1113.

The driving gear 1113 is rotated when the string 1114 is pulled. Since, as the diameter of the driving gear 1113 increases, the driving gear 1113 may transmit greater driving force to the power generation gear 1123, the driving gear 1113 has a greater diameter than other gears (i.e., the power generation gear 1123, the connection gear 1133).

The spiral spring 1112 is a plate spring which is wound in a spiral shape and has a structure, the winding width of which gradually increases in a direction from the center to the edge thereof As only one of one end of the spiral spring 1112 located at the center thereof and the other end of the spiral spring 1112 located at the edge thereof is rotated, the spiral spring 1112 is loosened when force is applied in a direction opposite the winding direction in the spiral shape and is wound into the original shape when the force is removed. On the other hand, the spiral spring 1112 is densely wound when force is applied in the winding direction in the spiral shape and is loosened into the original shape when the force is removed.

The diameter of a part 1113a on which the string 1114 is wound may be smaller than the overall diameter of the driving gear 1113 so that the driving gear 1113 may be rotated only if the string 1114 is slightly pulled. As exemplarily shown in FIG. 14, if a cylindrical member 1113a having a small diameter protrudes from one surface of the driving gear 1113 and the string 1114 is wound on the cylindrical member 1113, the RPM of the driving gear 1113 may be increased even if the string 1114 is slightly pulled.

In the present invention, one end of the spiral spring 1112 located at the center thereof is fixed to the driving shaft 1111 and the other end of the spiral spring 1112 is combined with the driving gear 1113. When the driving gear 1113 is rotated by pulling the string 1114, the other end of the spiral spring 1112 is rotated according to rotation of the driving gear 1113 but the end of the spiral spring 1112 fixed to the non-rotated driving shaft 111 does not move and, thus, the spiral spring 1112 is loosened.

When force of pulling the string 1113 is removed, the spiral spring 1112 returns to its original shape, the driving gear 1113 is rotated in the second direction, and the string 1114 is again wound on the driving gear 1113.

The spiral spring 1112 is inserted into a recess 1113b formed at the central part of one surface of the driving gear 1113 and may thus reduce the thickness of the manually operated power generation apparatus, as exemplarily shown in FIG. 13.

The connection unit 1130 includes the connection gear 1133 and a connection shaft 1131, is located between the driving gear 1113 and the power generation gear 1123, and is rotated about the connection shaft 1131. The connection gear 1133 has a smaller size than the size of the driving gear 1113 and may thus be rotated several times when the driving gear 1113 is rotated one time.

The power generation unit 1120 may include the power generation gear 1123, a power generation shaft 1121, a rotor 1127, stators 1128 and a one-way bearing 1125.

The power generation gear 1123 is rotated in the third direction when the driving unit 1110 is rotated in the first direction and, in this embodiment, the connection gear 1133 is interposed therebetween and, thus, the third direction is the same as the first direction. Since the diameter of the power generation gear 1123 is smaller than that of the driving gear 1113, the power generation gear 1123 may be rotated several tens of times when the driving gear 1113 is rotated one time. As the RPM of the power generation gear 112 increases, generated power increases.

The power generation shaft 1121 is combined with the power generation gear 1123 and is rotated together with rotation of the power generation gear 1123. When the power generation gear 1123 is rotated in the clockwise direction, the power generation shaft 1121 is rotated in the clockwise direction and, when the power generation gear 1123 is rotated in the counterclockwise direction, the power generation shaft 1121 is rotated in the counterclockwise direction. Hereinafter, for convenience of description, the case in that the third direction is the counterclockwise direction will be exemplarily described.

The rotor 1127 is a disc-shape member which is rotated about the power generation shaft 1121 as an axis, and includes a plurality of magnets 1127′ disposed in a circular shape. The magnets 1127′ have the N poles and S poles which are alternately arranged. When the rotor 1127 is rotated, the magnets 1127′ are rotated and form a magnetic field.

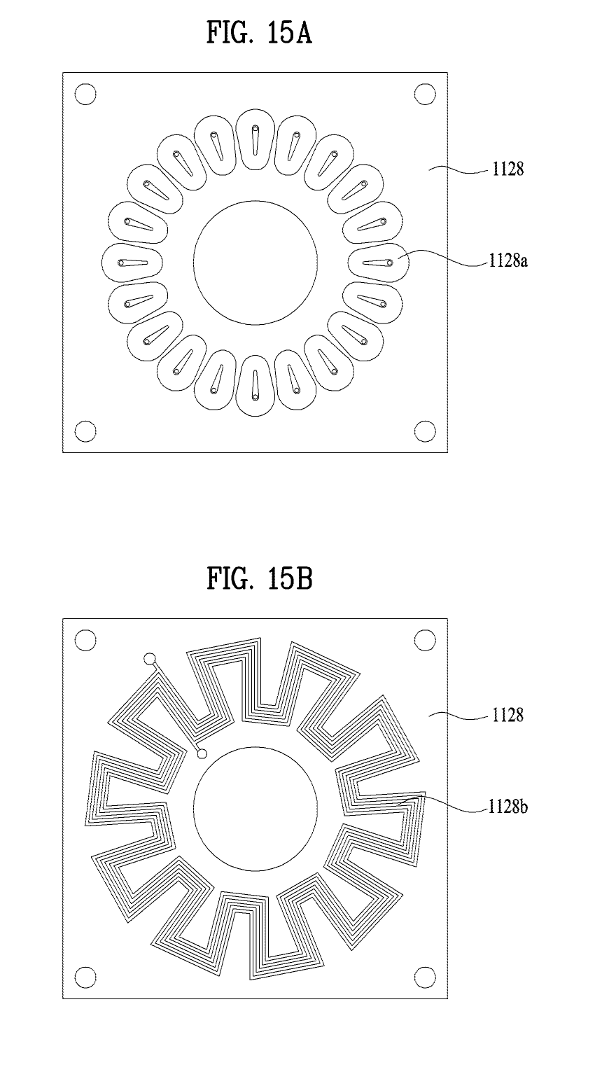

FIG. 15a is a plan view of a stator in accordance with one embodiment of the present invention and FIG. 15b is a plan view of a stator in accordance with another embodiment of the present invention.

A stator 1128 includes a coil 1128a or 1128b, and electricity flows on the coil 1128a or 1128b by a magnetic field generated by the rotor 1127 according to Fleming's right hand rule, thus generating power. In order to cause current to flow due to the magnetic field generated by the rotor 1127, the stator 1128 may be disposed such that the coil 1128a or 1128b is located at the circumference of the rotor 1127 or on the upper or lower surface of the rotor 1127.

Although this embodiment illustrates the stators 1128 as being located on the upper and lower surfaces of the rotor 1127 (1PM/2Coil), the disclosure is not limited thereto. That is, one rotor 1127 and one stator 1128 may be used, and a 2PM/1Coil structure including two rotors 1127 and one stator 1128 interposed therebetween may be used.

When the number of rotors 1127 increases, a strong magnetic field may be formed and generated power may be increased but, when the number of rotors 1127 increases, upper and lower spaces for rotation of the rotors 1127 are additionally required as well as a space corresponding to the thickness of the rotors 1127. Therefore, when the number of rotors 1127 increases, a space greater than the thickness of the rotors 1127 is required and, thus, the volume of the manually operated power generation device 1000 increases and the manually operated power generation device 1000 may be difficult to carry by hand.

Therefore, in this embodiment, in consideration of generated power and portability, two stators 1128 located on the upper and lower surfaces of one rotor 1127 may be used. In the case that portability is not important, as described above, the number of rotors 1127 and the number of stators 1128 may be increased.

As exemplarily shown in FIGS. 15a and 15b, the coil 1128a or 1128b may be disposed in a shape having a long length within a restricted area of the stator 1128. For example, the coil 1128a or 1128b may be disposed in a zigzag shape or a spiral shape.

The stator 1128 may include the coil 1128a or 1128b having a layered structure by printing a coil pattern formed of a conductive material on an insulating layer, stacking an insulating layer thereon and then printing a coil pattern formed of the conductive material thereon.

The coil patterns of respective layers, which are printed using the conductive material, are interconnected by through holes formed on the insulating layers, thus forming the coil 1128a or 1128b having a long length. By connecting the end of the coil 1128a or 1128b to a circuit unit, a rechargeable battery may be charged with power generated from the coil 1128a or 1128b or power may be supplied to an external electronic apparatus.

The method using the stators 1128 including the insulating layers and the coil patterns as in the above-described embodiment is referred to as an electromagnetic method and, in addition to the electromagnetic method, an electrostatic method may be used.

In the electrostatic method, capacitance may be changed to generate power according to movement of a rotor 1127. A fluid between two electrode plates may flow according to movement of the rotor and change capacitance and electrical charges, thus generating power.

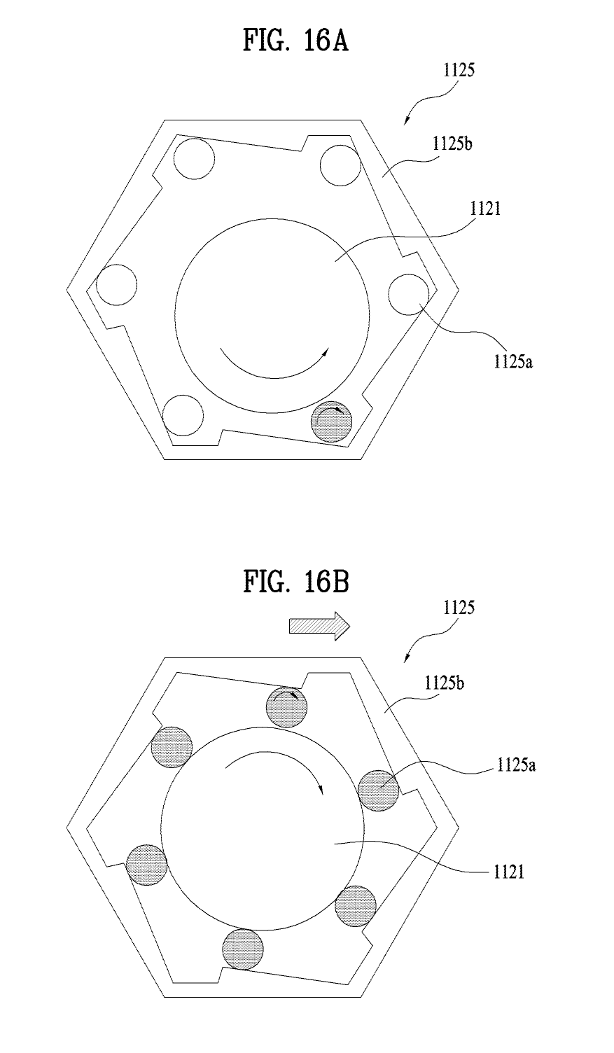

FIGS. 16a and 16b are plan views illustrating movement of a one-way bearing in accordance with the present invention.

The one-way bearing 1125 is divided into an external bearing 1125b and internal bearings 1125a. When a shaft inserted into the center of the one-way bearing 1125 is rotated in one direction, the internal bearings 1125a and the external bearing 1125b are rotated together with rotation of the shaft. However, when the shaft is rotated in the opposite direction, the external bearing 1125b and the internal bearings 1125a are separated from the shaft and, thus, only the shaft is rotated and the external bearing 1125b is not rotated.

When the power generation shaft 1121 is rotated in the third direction, the internal bearings 1125b and the external bearing 1125b of the one-way bearing 25 are integrally combined with the power generation shaft 1121 and, thus, the rotor 1127 is rotated, as exemplarily shown in FIG. 16b, but, when the power generation shaft 1121 is rotated in the opposite direction, the internal bearings 1125b and the external bearing 1125b of the one-way bearing 1125 are separated from the power generation shaft 1121 and, thus, only the power generation shaft 1121 is rotated and the rotor 1127 is not rotated, as exemplarily shown in FIG. 16a.

If a one-way clutch is used, noise may be generated when the one-way clutch is rotated in the reverse direction but, if the one-way bearing 1125 including the internal bearings 1125a formed in a circular bead shape (or a cylindrical shape) is used, noise may be reduced when the one-way bearing 1125 is rotated in the third direction or the opposite direction.

Further, the one-way bearing 1125 is inserted into the center of the rotor 1127, as exemplarily shown in FIG. 14, and may drive the rotor 1127 only in one direction without increase in the thickness and thus increase portability of the power generation device.

The power generation unit 1120 may further include a spring 1124, as exemplarily shown in FIG. 14. It serves to provide a spatial gap because the power generation gear 1123 and the rotor 1127 are rotated at a high speed. The spring 1124 is pressed when they are rotated and serves to fix the power generation unit 1120 so as not to move upward and downward when they are not rotated.

In order to transmit power generated by the power generation unit 1120 to the outside, an interface 1142 may be further provided. Power may be supplied to an external apparatus by connecting the interface 1142 to the external apparatus.

### MODE FOR INVENTION

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, various variations and modifications are possible in the component parts of these embodiments. Further, those skilled in the art will appreciate that differences related to these variations and modifications are within the scope of the disclosure, defined as disclosed in the accompanying claims.

### INDUSTRIAL APPLICABILITY

The present invention relates to an energy harvesting device and has industrial applicability.

1. An energy harvesting device comprising:
a chamber including a first electrode, a second electrode disposed so as to face the first electrode, a first fluid, a magnetic second fluid, and a second dielectric film disposed between the second electrode and the first fluid; and
magnets disposed at the outside of the chamber to cause the second fluid to flow.

2. The energy harvesting device according to claim 1, wherein the second fluid is conductive or non-conductive.

3. The energy harvesting device according to claim 1, wherein the first fluid is one of air, a conductive fluid and a non-conductive fluid.

4. The energy harvesting device according to claim 1, wherein the chamber has one of a channel shape, a cylindrical shape or a polygonal prism shape.

5. The energy harvesting device according to claim 1, wherein the second dielectric film includes one or two layers and contacts the second electrode.

6. The energy harvesting device according to claim 1, wherein the chamber further includes a first dielectric film disposed between the first electrode and the first fluid.

7. The energy harvesting device according to claim 1, wherein the first dielectric film includes one or two layers and contacts the first electrode.

8. The energy harvesting device according to claim 1, wherein the magnets move relative to the first fluid and the second fluid.

9. The energy harvesting device according to claim 8, wherein the magnets linearly move relative to the first fluid and the second fluid.

10. The energy harvesting device according to claim 8, wherein the magnets are rotated relative to the first fluid and the second fluid.

11. The energy harvesting device according to claim 10, wherein the magnets are disposed on a first plate and the chamber is disposed on a second plate.

12. The energy harvesting device according to claim 11, wherein the first plate and the second plate linearly move relative to each other.

13. The energy harvesting device according to claim 11, wherein the first plate and the second plate are rotated relative to each other.

14. The energy harvesting device according to claim 1, wherein the first fluid is hydrophilic, the second fluid is hydrophobic, and the chamber further includes a hydrophobic member disposed at a region on the second dielectric film corresponding to the second electrode.

15. The energy harvesting device according to claim 14, wherein the hydrophobic member is disposed at a position corresponding to the edge region of the second electrode.

16. The energy harvesting device according to claim 1, wherein the first fluid is hydrophilic, the second fluid is hydrophobic, and the chamber further includes a hydrophobic member disposed on the side walls of the chamber.

17. The energy harvesting device according to claim 1, wherein the number of the magnets is at least two and the at least two magnets are disposed such that poles thereof face opposite directions.

18. The energy harvesting device according to claim 17, wherein the at least two magnets are disposed such that poles thereof face equal directions.

19. The energy harvesting device according to claim 1, wherein the number of the magnets is at least two and the at least two magnets are disposed so as to face each other across the chamber.

20. The energy harvesting device according to claim 19, wherein the at least two magnets are disposed such that the same poles thereof face each other.
